(19) United States
(12) Patent Application Publication
(10) Pub. No.: US 2010/0270313 A1
(43) Pub. Date: Oct. 28, 2010

(54) ERGONOMIC PAINT TRAY AND ERGONOMIC APPLICATOR

(76) Inventors: Steven C. Gates, New Port Richey, FL (US); Brian Santos, New Port Richey, FL (US)

Correspondence Address: Workman Nydegger;1000 Eagle Gate Tower, 60 East South Temple, Salt Lake City, UT, 84111, US

(21) Appl. No.: 12/819,133

(22) Filed: Jun. 18, 2010

Related U.S. Application Data
(63) Continuation-in-part of application No. 11/743,420, filed on May 2, 2007, now abandoned.
Application No. 11/743,420 is a continuation-in-part of application No. 11/743,486, filed on May 2, 2007.
(60) Provisional application No. 60/796,747, filed on May 2, 2006.
(60) Provisional application No. 60/797,007, filed on May 2, 2006.

(51) Int. Cl. B05C 21/00

(52) U.S. Cl. 220/570; 15/209.1

(57) ABSTRACT

An open-topped paint tray includes an upwardly-opening paint-retaining cavity defined by a pair of sidewalls, a pair of end walls, and an imperforate bottom wall. The cavity includes a main cavity with an arcuate bottom wall and a secondary cavity having a straight, downwardly inclined bottom wall. A hollow stiffening rib having a gradual “S” shape is formed integrally with the paint tray bottom wall and enables a user to hold the paint tray in one hand. A roller cover wash shield releasably engages the paint tray and defines a downwardly-opening cavity that together with the upwardly-opening paint retaining cavity provides a primary cavity for cleaning a paint roller cover. A flap formed in the roller cover wash shield admits a wand having a nozzle that spins and cleans a paint roller cover, positioned within the primary cavity, with water under pressure.

### CROSS-REFERENCE TO RELATED APPLICATIONS

This application is a continuation-in-part of U.S. patent application Ser. No. 11/743,420, filed on May 5, 2007, which claims the benefit of priority to U.S. Provisional Patent Application No. 60/796,747, filed on May 2, 2006. This application is also a continuation-in-part of U.S. patent application Ser. No. 11/743,486, filed on May 5, 2007, which claims the benefit of priority to U.S. Provisional Patent Application No. 60/797,007, filed on May 2, 2006. The entire content of each of the aforementioned patent applications is incorporated by reference herein.

### BACKGROUND OF THE INVENTION

1. The Field of the Invention

Implementations of the present invention relate to equipment that facilitates the application of paint to various surfaces. More particularly, it relates to a tray for holding paint that has a handle formed in its bottom wall that facilitates holding of the tray in one hand.

2. Description of the Prior Art

Commercially available paint trays are sold in many different sizes. Some of them are too big, bulky, or heavy to easily hold in one hand. Some of them are too small and flimsy. Others have inadequate roller handles, and users can not substitute better roller handles sold separately to get the desired paint application and finish on surfaces that are being painted. A further problem is that conventional paint trays can only be used in tray function uses.

Accordingly, there are a number of disadvantages in the art that can be addressed.

### SUMMARY OF THE INVENTION

Implementations of the invention provide a paint tray that incorporates ergonomic principles.

Although there are many commercially available paint trays, few if any incorporate the art of ergonomics. The novel tray incorporates ergonomic principles and includes the following advantages.

The novel paint tray includes a stiffening rib in the shape of an “S” curve that facilitates comfortable and easy holding of the tray by users having hand sizes that range from very small to very large. The paint tray further includes a curved bottom rake that enables a user to smoothly roll a paint roller cover through it. The “S” curve stiffening rib runs the length of the tray and channels paint in the tray to prevent paint from sloshing out of the tray as the roller cover passes through it. Moreover, finger location indents are formed in the sides of the tray to enhance the user's grip. A protrusion on opposite sides of the tray bottom provides an additional surface for users to hold the tray with their fingers. A smaller well on one end of the tray may hold a paint roller cover attached to a paint roller handle while the paint roller handle rests in the water and paint exit spout preventing the roller handle from falling into the paint, in the tray during use.

More particularly, the novel paint tray has a leading end and a trailing end and includes an open-topped paint-retaining cavity defined by a pair of transversely opposed, longitudinally extending sidewalls, a pair of transversely disposed end walls, and an imperforate bottom wall. The transversely disposed end walls include a leading end wall having a first height and a trailing end wall having a second height. The open-topped paint-retaining cavity includes a main cavity that extends from the leading end of the paint tray to a preselected transverse line beyond the mid-point of the paint tray. The open-topped paint-retaining cavity also includes a secondary cavity that extends from the preselected transverse line to the trailing end wall. The bottom wall is arcuate along the extent of the main cavity so that the main cavity is deepest about mid-length of the main cavity. The bottom wall is straight and inclined downwardly along the extent of the secondary cavity from the preselected transverse line to a bottom edge of the trailing end wall.

A hollow stiffening rib has a gradual “S” shape, a longitudinal extent substantially equal to a longitudinal extent of the paint-retaining cavity, is formed integrally with the paint tray bottom wall, and is positioned about mid-width of the paint tray. The stiffening rib has a bottom wall disposed in a substantially horizontal plane when the paint tray is in a substantially level, functional position and the stiffening rib bottom wall is substantially coplanar with a lower edge of the trailing end wall. A first plurality of finger-receiving indentations is formed in a first sidewall of the paint tray and a second plurality of finger-receiving indentations is formed in a second sidewall of the paint tray. A user may therefore hold the paint tray in one hand by placing fingers of a first hand in the first plurality of finger-receiving indentations and a thumb of the first hand against the stiffening rib.

In the alternative, a user may hold the paint tray in one hand by placing a thumb of a first hand in a preselected finger-receiving indentation of the first plurality of fingerreceiving indentations and fingers of the first hand against the stiffening rib. Similarly, a user may hold the paint tray in one hand by placing fingers of a first hand in the second plurality of finger-receiving indentations and a thumb of the first hand against the stiffening rib or the user may hold the paint tray in one hand by placing a thumb of a first hand in a preselected finger-receiving indentation of the second plurality of finger-receiving indentations and fingers of the first hand against the stiffening rib.

A paint applicator roller has a transverse extent slightly less than a width of the open-topped paint retaining cavity and is disposed transversely in the main cavity about mid-length thereof. A transversely disposed axle extends from opposite ends of the paint applicator roller. Each of the longitudinally-extending sidewalls of the paint tray is adapted to rotatably engage an axle extending from the paint applicator roller.

A peripheral flange extends outwardly in a substantially horizontal plane from the longitudinally-extending sidewalls and the transversely disposed end walls. The peripheral flange is bent downwardly about ninety degrees at its outer edges to form longitudinally-extending and transversely disposed flange vertical walls. The flange vertical walls are bent at their respective lower edges about ninety degrees into a substantially horizontal plane.

A roller cover wash shield is adapted to engage the paint tray in covering relation to the open-topped paint-retaining cavity. A roller cover cleaning space is defined between the paint tray and the roller cover wash shield. The roller cover wash shield is adapted to accommodate a handle of a paint roller when the roller cover wash shield is engaged to the paint tray. The roller cover wash shield includes a first downwardly-opening main cavity defined by an arcuate top wall. The greatest height of the downwardly-opening main cavity is about mid-length of the downwardly-opening cavity. The downwardly-opening main cavity is positioned in open communication with the open-topped main cavity of the paint tray.

Accordingly, the two confronting cavities combine to form a single primary cavity, or roller cover cleaning space, that can accommodate a roller brush cover. The roller cover wash shield also includes a second downwardly-opening cavity defined by a tunnel-like section that accommodates a handle of a paint roller. The second downwardly-opening cavity is in open communication with the first downwardly-opening main cavity and hence with the primary cavity when the roller cover wash shield is in engagement with the paint tray.

A wand has a discharge nozzle and is in fluid communication with a source of water under pressure. A slot is formed in the top wall of the roller cover wash shield to admit the wand into the roller cover cleaning space. A paint roller cover having a handle is positioned in the roller cover cleaning space, with the handle accommodated within the tunnel-like section of the roller cover wash shield. Opening the source of water under pressure causes the roller cover to spin as water flows from the nozzle onto the roller cover. This cleans the roller cover. The roller cover wash shield and paint tray together provide a shield that confines the water and paint spray generated by such spinning to the confines of the primary cavity.

An important object of the invention is to provide a paint tray that can easily be held in one hand.

Another important object is to provide a paint tray having a main paint-retaining cavity and a secondary paint-retaining cavity.

Still another important object is to provide a roller cover wash shield that is releasably attachable to a paint tray so that a paint roller cover may be cleaned at the end of a job by using the paint tray and the roller cover wash shield as a unit.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a side elevational view of the novel “S” grip paint tray;

FIG. 2 is a top plan view of the novel tray;

FIG. 3 is a bottom plan view of the novel tray;

FIG. 4 is a side elevational view of the “S” grip tray with a wash shield attached;

FIG. 5 is a top plan view of the parts depicted in FIG. 4; and

FIG. 6 is an end view of the “S” grip tray with the wash shield attached.

### DETAILED DESCRIPTION OF THE PREFERRED EMBODIMENT

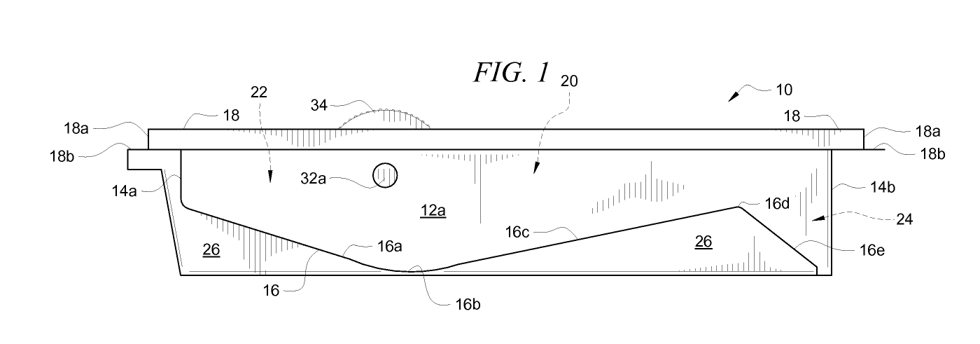

Referring now to FIGS. 1-3, it will there be seen that an improved ergonomic paint tray that is comfortable and easy to hold with small or large hands is denoted as a whole by the reference numeral 10. Paint tray 10 has a generally rectangular shape when viewed in plan and defines an open-top cavity for retaining paint therewithin. It includes longitudinally-extending upstanding sidewalls 12a, 12b, transversely extending upstanding end walls 14a, 14b and an imperforate bottom wall 16 formed integrally with the respective bottom edges of said sidewalls and end walls. The term “upstanding” may be interpreted as “vertical,” it being understood that the sidewalls and end walls are generally vertical when paint tray 10 has paint contained therein and is in its generally horizontal, functional position.

A thin, flat, horizontally disposed peripheral flange 18 is formed integrally with and extends outwardly from the respective upper edges of sidewalls 12 and end walls 14. Peripheral flange 18 is bent downwardly by about ninety degrees (90°) at its outermost edge, thereby forming vertical flange sidewalls 18a. Said vertical flange sidewalls 18a are bent about ninety degrees (90°) outwardly so that they are disposed in a horizontal plane, thereby forming horizontal flange walls 18b.

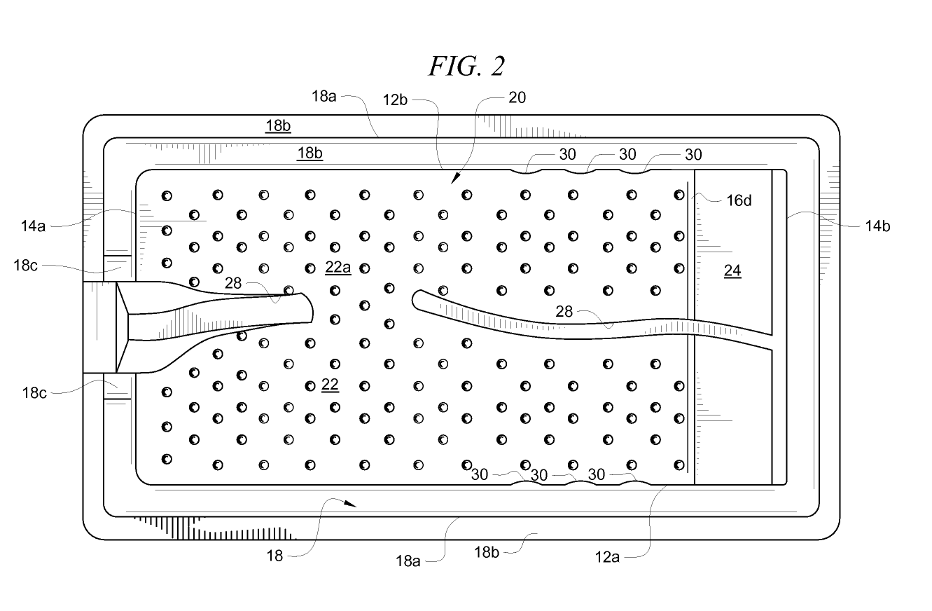

As best understood in connection with FIG. 1, paint-retaining cavity 20 does not have a uniform depth. Defining the left end of tray 10 as the leading end and the right end thereof as the trailing end, it will be observed that leading end wall 14a has a height extent less than that of trailing end wall 14b. The leading end of bottom wall 16 begins at the lowermost end of leading trailing wall 14a and is curved downwardly as at 16a until it reaches a depth substantially equal to the height of trailing end wall 14b, said maximum depth being denoted 16b. Bottom wall 16 then curves gradually upwardly as at 16c as it extends toward the trailing end of the paint tray until it reaches a depth about equal to the height of leading end wall 14a. A transverse line that corresponds with that depth is denoted 16d in FIG. 2. Bottom wall 16 then has a linear section 16e that extends downwardly at a roughly forty five degree (45°) angle to the lowermost edge of trailing end wall 14b. Bottom wall 16 thus creates a main cavity 22 having a curved bottom wall and a trailing or secondary cavity 24 having an inclined bottom wall.

Hollow stiffening rib 26 is formed integrally with bottom wall 16 of tray 10. Stiffening rib 26 is “S”-shaped and substantially extends the entire length of paint tray 10 in this preferred embodiment. However, an “S-shaped stiffening rib that extends less than the entire length of the tray is also within the scope of this invention, as is a stiffening rib that is straight or that has varying degrees of curvature. In this embodiment, the stiffening rib is discontinuous in the region 22a where main paint-retaining cavity 22 is deepest. The longitudinal axis of symmetry of stiffening rib 26 is positioned substantially centrally of bottom wall 16, equidistant from sidewalls 12a, 12b.

Stiffening rib 26 has a hollow structure and therefore creates an “S”-shaped secondary cavity 28, depicted in the top plan view of FIG. 2, having a depth greater than the depth of main paint-retaining cavity 22 for most of the extent of the tray, with the exception being a short distance where the depth of main cavity 22 reaches its greatest depth, i.e., at region 22a where stiffening rib 26 is discontinuous.

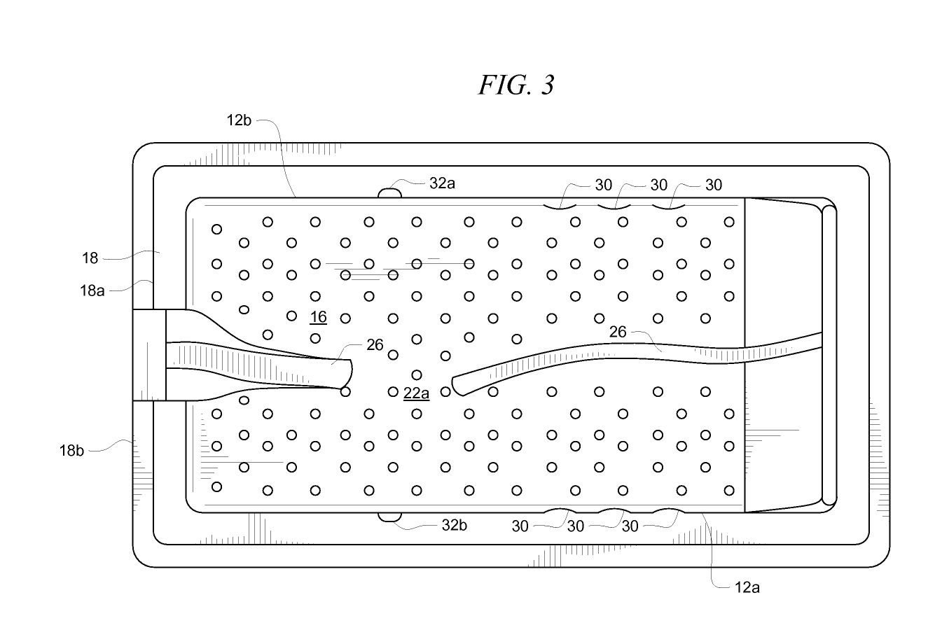

A plurality of indentations, collectively denoted 30, is formed in sidewalls 12a, 12b of paint tray 10. These indentations are adapted to accommodate the fingers or fingertips of a user when the tray is held in one hand. More particularly, a user places a thumb against a first side of stiffening rib 26 that faces away from the sidewall 12a or 12b to be grasped, and places one or more fingers of the same hand in indentations 30 formed in said sidewall. For example, as perhaps best understood in connection with the bottom plan view of FIG. 3, a user places a thumb on the lower side of stiffener rib 26 and the fingers in the indentations 30 formed in the sidewall at the top of said Fig. In the alternative, a user places a thumb on the top side of stiffener 26 and positions the fingers of the same hand in indentations 30 formed in the sidewall at the bottom of said figure.

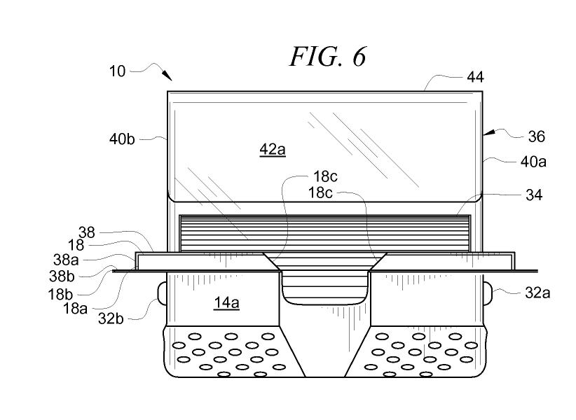

Peripheral flange 18 is discontinuous at the leading end of tray 10, as is vertical flange sidewall 18a. Horizontal flange wall 18b is not discontinuous but it is sloped downwardly at the discontinuity as at 18c, as best depicted in FIG. 6, to form a cradle for the handle of a paint roller, not depicted. This cradle enables a user to position a roller cover attached to a paint roller handle into trailing paint cavity 24 and rest the roller handle in the cradle area atop horizontal flange wall 18c to keep the roller handle out of the paint in main paint-receiving cavity 22 when the user desires to set a paint roller down.

A button-shaped protrusion 32a, 32b is formed in each sidewall 12a, 12b, respectively, as best depicted in FIG. 2-4. Each protrusion forms a concavity when viewed from the inside of main paint-retaining cavity 22. An axle protruding from opposite ends of rotatable paint applicator wheel 34 is snapped into said concavities so that a user can apply paint onto the pad of a typical paint pad. Each axle spins about its axis of rotation when the paint applicator is rotated.

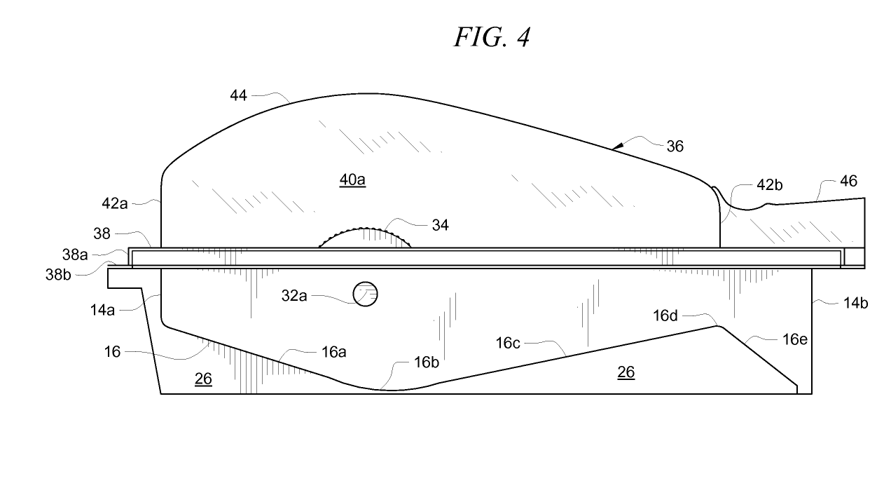

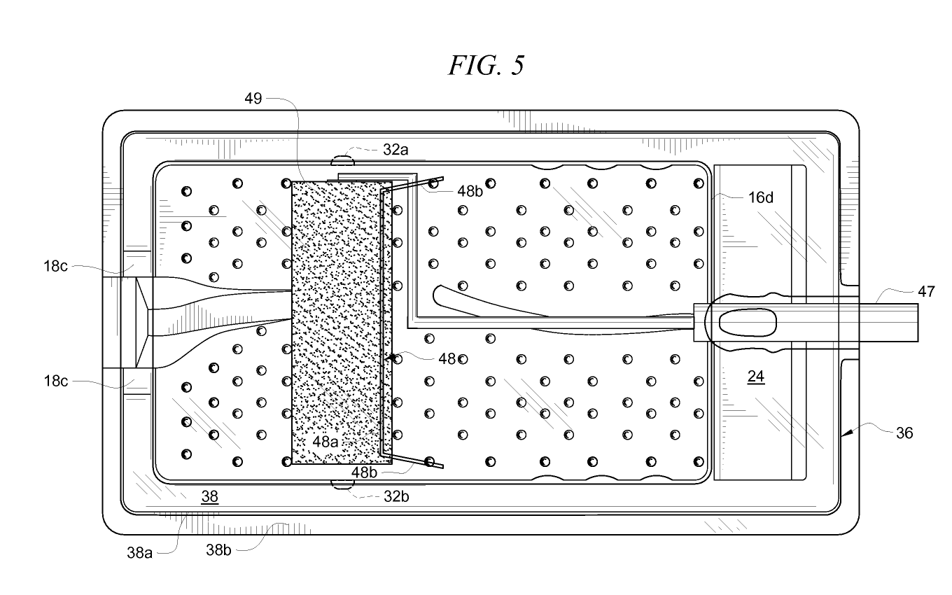

Roller cover wash shield 36, depicted in FIGS. 4 and 5, acts as a cover for paint tray 10 when said paint tray is converted into a washing housing that encloses a paint roller cover during cleaning Roller cover wash shield 36 includes thin, flat peripheral flange 38 that is horizontally disposed and adapted to overlie and abuttingly engage peripheral flange 18 of paint tray 10. Peripheral flange 38 is bent downwardly about ninety degrees (90°) to form vertical flange sidewall 38a that abuttingly engages vertical flange sidewall 18a of paint tray 10 when peripheral flange 38 abuts peripheral flange 18. Vertical flange sidewall 38a is bent about ninety degrees (90°) in a horizontal plane and in an outward direction to form horizontal flange 38b that overlies and abuttingly engages horizontal flange 18b when roller cover wash shield 36 is engaged to paint tray 10.

As best depicted in FIG. 4, roller cover wash shield 36 includes vertical sidewalls 40a, 40b and vertical end walls 42a, 42b. The respective upper edges of vertical sidewalls 40a, 40b are curved as depicted and the peripheral edges of curved top wall 44 are formed integrally with the respective top edges of vertical sidewalls 40a, 40b and vertical end walls 42a, 42b. The curvature is substantially a mirror image of the curvature formed in bottom wall 16 of main paint-retaining cavity 22, i.e., top wall 44 reaches its zenith in diametrically opposed relation to the point where bottom wall 16 reaches its nadir as at 16b. Sidewalls 40a, 40b, end walls 42a, 42b, and top wall 44 collectively form the main part of roller cover wash shield 36.

Horizontal flange 38 is also bent so that it forms a tunnel-shaped passageway 46 that is in open communication with the trailing end of roller cover wash shield 36. Passageway 46 accommodates a paint roller handle.

Slot 48 is formed in top wall 44 of shield 36 and has a transverse part 48a from opposite ends of which extend generally longitudinal slots 48b, 48b. The slots collectively form a generally square “U”-shaped flap. A user snaps roller cover wash shield 36 onto tray 10 so that a paint roller handle 47 is in passageway 46 and a paint roller cover 49 is positioned in an open space bounded at its bottom by tray 10 and at its top by shield 36. A suitable wand is inserted through the flexible flap which is momentarily displaced as the wand is inserted through it and which closes under its inherent bias when the wand is properly inserted into said open space. Water under pressure is then sprayed from the wand onto the edge of the paint roller cover. The force of the water spins the roller cover and paint is removed therefrom by centrifugal force, as more fully disclosed in U.S. Pat. No. 5,797,410.

Novel tray 10 can also be used with better roller handles and covers so that a user may substitute such roller handles and covers as may be required for various jobs. For example, the paint tray having a roller handle wash shield attachment, disclosed in U.S. Pat. No. 5,797,410 may be used as a second shield half for cleaning roller covers. Paint tray 10 may also be used for packaging quality roller handles and roller covers so said paint tray, handles, and covers can be sold together.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

We claim:

1. A paint tray configured in size and shape to enable portability by the end-user during painting use and during cleaning, comprising:
a bottom wall for receiving and holding paint, the paint tray having a generally rectangular shape defined by a length that is longer than its width;
an s-shaped stiffening rib extending essentially perpendicularly from the bottom wall, and running along the length of the bottom wall, wherein the stiffening rib is configured in size and shape for gripping by the hand of an end-user;
wherein the s-shaped stiffening rib is hollow on a side of the bottom wall that receives and holds paint, such that the stiffening rib provides a channel for collecting paint in the bottom wall.

2. A paint tray system configured in size and shape to enable portability by the end-user during painting use, and to enable simple cleaning after painting use, comprising:
a rectangular paint tray with a bottom wall having a length that is longer than its width, the bottom wall further including an s-curved rib configured as a grip for an end user on one side of the bottom wall, and as a corresponding channel for receiving paint on an opposite side thereof;
a clear wash shield configured to align with and be secured to each side wall of the rectangular paint tray, the clear wash shield further comprising a dome portion with an elongate perforation along the width thereof; and
a wash nozzle configured for use in cleaning the rectangular paint tray by insertion directly within the elongate perforation;
wherein the paint tray and wash shield are configured in size and shape to receive a paint roller and corresponding handle when the wash shield and paint tray are aligned and secured together.

3. A paint applicator, comprising:
a hollow dome-shaped handle configured for gripping by a human hand;
a paint pad configured for removable attachment from the dome-shaped handle; and
a paint applicator material secured in depending relation to said paint pad;
wherein the paint pad comprises a memory material such that the paint pad can flex from an position to a subsequent position when being attached to the handle, that the paint pad can return automatically to the initial position after detachment from the handle.
